(19) United States
(12) Patent Application Publication
(10) Pub. No.: US 2024/0354906 A1
(43) Pub. Date: Oct. 24, 2024

(54) ANOMALY DETECTION APPARATUS AND ANOMALY DETECTION METHOD

(71) Applicant: SK Planet Co., Ltd., Seongnam-si (KR)

(72) Inventors: Yeong Hyeon PARK, Cheonan-si (KR); Myung Jin KIM, Seoul (KR)

(21) Appl. No.: 18/632,327

(22) Filed: Apr. 11, 2024

(30) Foreign Application Priority Data
Apr. 18, 2023 (KR) 10-2023-0050741

(51) Int. Cl. G06T 5/60; G06T 7/00

(52) U.S. Cl. CPC G06T 5/60; G06T 7/0002

(57) ABSTRACT

The present disclosure relates to a method for improving performance of anomaly detection by applying a scheme of maximizing a restoration loss for an abnormal image, unlike a normal image, the restoration loss of which is minimized.

### CROSS-REFERENCE TO RELATED APPLICATION

This application is based on and claims priority under 35 U.S.C. 119 (a) to Republic of Korean Patent Application No. 10-2023-0050741, filed on Apr. 18, 2023, in the Korean Intellectual Property Office, the disclosure of which is herein incorporated by reference in its entirety.

### BACKGROUND OF THE INVENTION

### 1. Field of the Invention

The present disclosure relates to a method for improving performance of anomaly detection by applying a scheme of maximizing a restoration loss for an abnormal image, unlike a normal image, the restoration loss of which is minimized.

### 2. Description of the Prior Art

In order to provide consumers with a product having a constant quality, product defect detection or defect type classification are requisite on an industry site.

Recently, these operations are being automated upon introduction of a machine learning algorithm, but configuring a training data set is not easy due to low frequency of occurrence of a defective product.

In other words, there is limitation in that, in order to verify whether a machine learning algorithm has been correctly trained to perform a given task, data of sufficient good products and defective products is required and specifically, the types of the defective products also need to be diversified.

Accordingly, configuring a training data set is not easy due to low frequency of occurrence of a defective product, and unsupervised learning anomaly detection technique is widely adapted to solve this problem.

The present disclosure proposes a new anomaly detection method in which unsupervised learning anomaly detection in consideration of low frequency of occurrence of defective products and performance of anomaly detection can be improved without a change in the scale of an artificial neural network.

### SUMMARY OF THE INVENTION

The present disclosure is to improve performance of anomaly detection by applying a scheme of maximizing a restoration loss for an abnormal image, unlike a normal image, the restoration loss of which is minimized.

An anomaly detection apparatus according to an embodiment of the present disclosure includes: a preprocessing unit configured to generate a context image obtained by removing detailed information from an input image; a restoration unit configured to approximate the context image to the input image through an artificial neural network so as to convert the approximated context image into a restoration image; and a determination unit configured to determine, based on a loss between the input image and the restoration image converted from the context image, whether the input image is abnormal.

Specifically, the apparatus may further include a training unit configured to train the artificial neural network in a scheme of restoring detailed information removed from a normal training image.

Specifically, the training unit may be configured to update a parameter of the artificial neural network so that a loss between the training image and a restoration image obtained by approximating a context image from which the detailed information is removed from the training image to the training image falls within a configuration value.

Specifically, the determination unit may be configured to determine that the input image is abnormal in case that the loss between the input image and the restoration image converted from the context image is equal to or greater than a threshold value.

An anomaly detection method according to an embodiment of the present disclosure may include: preprocessing in which a context image obtained by removing detailed information from an input image is generated; restoration in which the context image is approximated to the input image through an artificial neural network so as to be converted into a restoration image; and determination in which whether the input image is abnormal is determined, based on a loss between the input image and the restoration image converted from the context image.

Specifically, the method may further include training in which the artificial neural network is trained in a scheme of restoring detailed information removed from a normal training image.

Specifically, the training may include updating a parameter of the artificial neural network so that a loss between the training image and a restoration image obtained by approximating a context image from which the detailed information is removed from the training image to the training image falls within a configuration value.

Specifically, the determination may include determining that the input image is abnormal in case that the loss between the input image and the restoration image converted from the context image is equal to or greater than a threshold value.

According to an anomaly detection apparatus and an anomaly detection method of the present disclosure, unlike a normal image, the restoration loss of which is minimized, image conversion of maximizing a restoration loss for an abnormal image is performed using an artificial neural network trained to restore again detailed information removed from a normal image (data), whereby the performance of anomaly detection can be greatly improved.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 illustrates an example of an anomaly detection environment according to an embodiment of the present disclosure.

FIG. 2 is a diagram illustrating elements of an anomaly detection apparatus according to an embodiment of the present disclosure.

FIG. 3 illustrates an example of an artificial neural network training process according to an embodiment of the present disclosure.

FIG. 4 illustrates an example for illustrating an artificial neural network training process according to an embodiment of the present disclosure.

FIG. 5 illustrates an example of an artificial neural network training process according to an embodiment of the present disclosure.

FIG. 6 illustrates an example for illustrating an anomaly detection process according to an embodiment of the present disclosure.

FIG. 7 illustrates an example for illustrating an anomaly detection process according to an embodiment of the present disclosure.

FIG. 8 illustrates an example for illustrating an anomaly detection process according to an embodiment of the present disclosure.

FIG. 9 is a flow chart illustrating an anomaly detection method according to an embodiment of the present disclosure.

### DETAILED DESCRIPTION OF THE EXEMPLARY EMBODIMENTS

It should be noted that the technical terms used herein are only used to describe specific embodiments, and are not intended to limit the technical idea of the present disclosure.

In addition, unless particularly defined otherwise herein, the technical terms as used herein should be interpreted to have the same meaning as those commonly understood by a person skilled in the art to which the present disclosure pertains, and should not to be interpreted to have excessively comprehensive or excessively restricted meanings.

Furthermore, when the technical terms as used herein are erroneous technical terms that fail to accurately express the technical idea of the disclosure, they should be interpreted as alternative technical terms that can be correctly understood by a person skilled in the art. Also, general terms as used herein should be interpreted to have the meanings defined in dictionaries or the contextual meanings in the relevant field of art, and are not to be interpreted to have excessively reduced meanings.

Hereinafter, exemplary embodiments according to the present disclosure will be described in detail with reference to the accompanying drawings. Regardless of reference signs, the same or like elements are provided with the same or like reference numerals in the drawings, and

Furthermore, in describing the present disclosure, a detailed description of known functions or configurations incorporated herein will be omitted when it is determined that the description may make the subject matter of the present disclosure unclear.

Furthermore, it should be noted that the accompanying drawings are merely for the purpose of easy understanding of the technical idea of the present disclosure, and are not to be interpreted to limit the technical idea. The spirit of the present disclosure should be construed to extend to all changes, equivalents, and alternatives, in addition to the drawings.

Hereinafter, exemplary embodiments of the present disclosure will be described with reference to the accompanying drawings.

An embodiment of the present disclosure relates to a machine learning-based anomaly detection technology.

In relation thereto, in order to provide consumers with a product having a constant quality, product defect detection or defect type classification are requisite on an industry site.

Recently, these operations are being automated upon introduction of a machine learning algorithm, but configuring a training data set is not easy due to low frequency of occurrence of a defective product.

In other words, there is limitation in that, in order to verify whether a machine learning algorithm has been correctly trained to perform a given task, data of sufficient good products and defective products is required and specifically, the types of the defective products also need to be diversified.

Accordingly, configuring a training data set is not easy due to low frequency of occurrence of a defective product, and unsupervised learning anomaly detection technique is widely adapted to solve this problem.

The present disclosure proposes a new anomaly detection method in which unsupervised learning anomaly detection in consideration of low frequency of occurrence of defective products and performance of anomaly detection can be improved without a change in the scale of an artificial neural network.

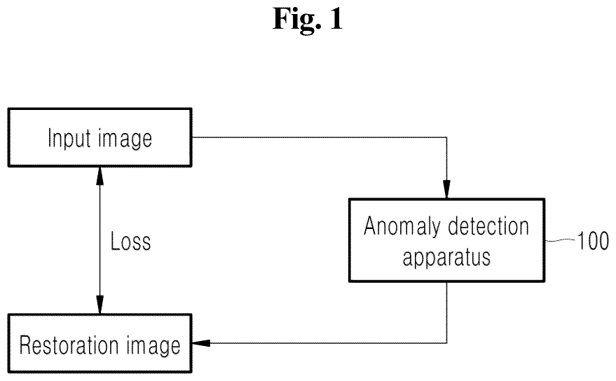

In relation thereto, FIG. 1 illustrates an example of an anomaly detection environment according to an embodiment of the present disclosure.

As illustrated in FIG. 1, an anomaly detection environment according to an embodiment of the present disclosure may include an anomaly detection apparatus 100 configured to determine whether an input image is abnormal.

The anomaly detection apparatus (100) refers to an apparatus configured to determine an abnormality by using an artificial neural network trained to restore again detailed information removed from a normal image (data).

Such an anomaly detection apparatus 100 may be implemented in the form of a server of a computing device (e.g., PC and smartphone) equipped with software (e.g., application).

If the anomaly detection apparatus (100) is implemented in the form of a server, the anomaly detection apparatus may be implemented in the form of, for example, a web server, a database server, a proxy server, or the like, may have one or more of various software, which a network load distribution mechanism or a service device to operate on the Internet or other networks, installed therein, and may be implemented by a computerized system.

In a training data generation environment according to an embodiment of the present disclosure, unlike a normal image, the restoration loss of which is minimized through the above-described configuration, anomaly detection can be performed by applying a scheme of maximizing a restoration loss for an abnormal image, and hereinafter, the configuration of the anomaly detection apparatus 100 for implementing same is descried in more detail.

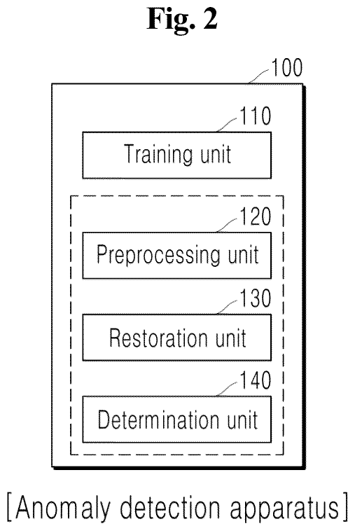

FIG. 2 schematically illustrates elements of an anomaly detection apparatus 100 according to an embodiment of the present disclosure.

As illustrated in FIG. 2, an anomaly detection apparatus 100 according to an embodiment of the present disclosure may include a preprocessing unit 120 configured to perform preprocessing, a restoration unit 130 configured to perform conversion of an image, and a determination unit 140 configured to determine whether an image is abnormal.

In addition, the anomaly detection apparatus 100 according to an embodiment of the present disclosure may further include a training unit 110 for training an artificial neural network, in addition to the above-described elements.

The entire or at least some of the elements of the anomaly detection apparatus 100 may be implemented in the form of a hardware module or a software module, or may be also implemented in the form of a combination of a hardware module and a software module.

Here, the software module may be understood as, for example, an instruction executed by a processor configured to control operation within the anomaly detection apparatus 100, and such an instruction may be mounted in a memory within the anomaly detection apparatus 100.

Through the above-described configuration, the anomaly detection apparatus 100 according to an embodiment of the present disclosure may improve the perform of detecting an abnormality by applying a scheme of maximizing a restoration loss for an abnormal image, unlike a normal image, the restoration loss of which is minimized, and hereinafter, a more detailed description of the elements in the anomaly detection apparatus 100 for implementing the same are made.

The training unit 110 is configured to perform a function of training an artificial neural network for image restoration.

More specifically, the training unit 110 is configured to train the artificial neural network for image restoration in the scheme of restore again detailed information removed from a normal training image.

To this end, the training unit 110 is configured to perform preprocessing for removing the detailed information from the normal training image.

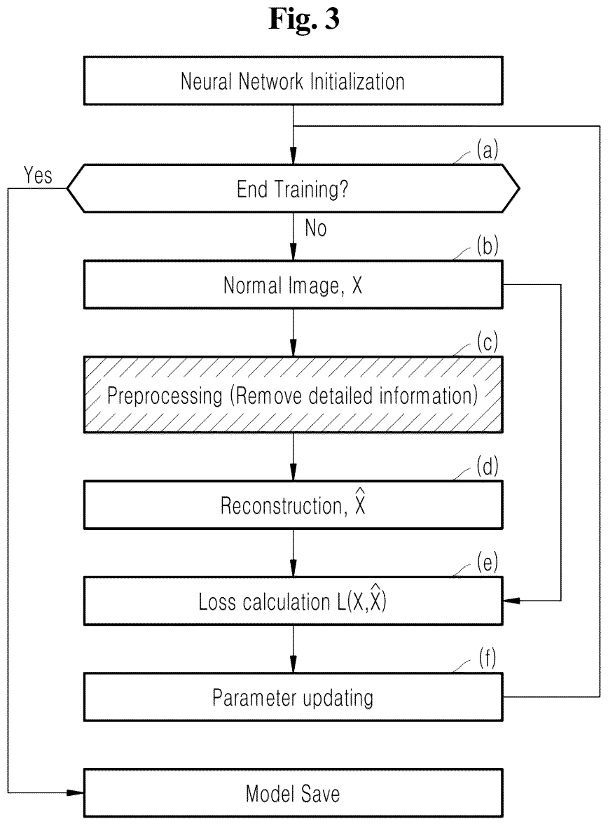

This corresponds to, for example, a preprocessing process (c) in FIG. 3 in which when a normal training image is input (a and b), a context image is generated in a scheme of removing detailed information from the input training image X.

According to an embodiment of the present disclosure, the above-described preprocessing process is based on the fact that a separate artificial neural network for performing preprocessing is not required.

Accordingly, the training unit 110 may generate a context image obtained by removing detailed information from the normal training image by applying, as a preprocessing scheme of requiring no artificial neural network, at least one preprocessing scheme among, for example, mosaic processing (mosaic to image (M2I)), quantization processing (quantized image to image (Q2I)), blurring processing (blurred image to image (B2I)), edge processing (edge image to image (E2I)), and noise processing (noisy image to image (N21)).

According to an embodiment of the present disclosure, unlike the above-described preprocessing scheme of requiring no separate artificial neural network, the preprocessing may be also performed through the artificial neural network.

In this case, the training unit 110 may generate a context image obtained by removing detailed information from a normal training image by applying, as a preprocessing scheme using an artificial neural network, at least one preprocessing scheme among, for example, an attention map (attention map to image (A2I)), a depth map (depth map to image (D2I)), and a segmentation map (segmentation map to image (S2I)).

In addition, the training unit 110 converts the context image into a restoration image through the artificial neural network when the context image obtained by removing the detailed information from the normal training image is generated.

This corresponds to a restoration process (d) in FIG. 3 above, in which the context image is approximated to a training image X before removal of the detailed information through the artificial neural network, and converted into a restoration image \hat{X}, after the context image generation through preprocessing (c).

In a case of the artificial neural network for converting the context image into the restoration image, for example, U-Net, which is widely used for image conversion, may be used, but the configuration thereof can be changed if image conversion can be performed.

In configuring the artificial neural network, a convolutional neural network widely used for image processing may be used, and there is no separate limit so that a feed forward network (multi-layer perceptron), a recurrent neural network, and a graph neural network can be selectively used, or one or more of the above-described schemes can be combined.

The training unit 110 is configured to repeat, when the context image is converted into the restoration image obtained by approximating the training image through the artificial neural network, parameter updating until a loss between the converted restoration image and the training image falls within a configuration value.

This corresponds to a process (e) of calculating a loss between the restoration image \hat{X} and the training image X, and an updating process (f) in which parameter updating of the artificial neural network is repeated until the calculated loss falls within the configuration value, after the restoration process (d) of approximating the context image to the training image before removal of the detailed information and converting the same into the restoration image \hat{X}.

The artificial neural network according to an embodiment of the present disclosure is trained to receive an input obtained by removing detailed information and converting the same into an image before removal of the detailed information, and according this rule, the training is performed in the direction of minimizing a loss between an original image and an output obtained from the artificial neural network.

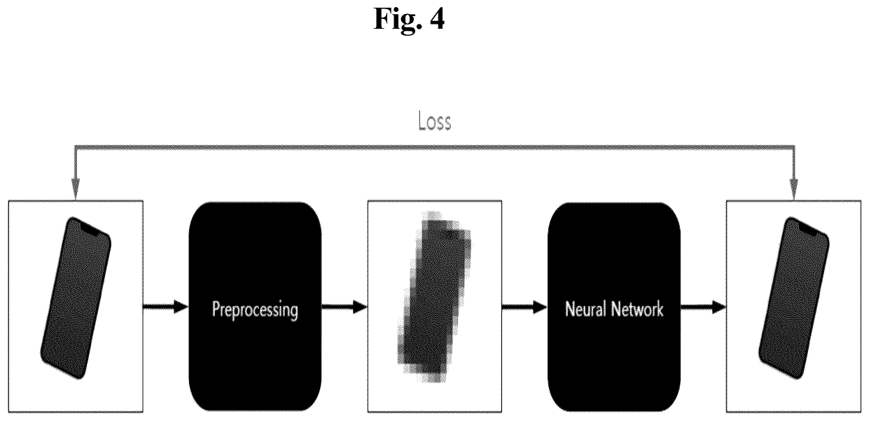

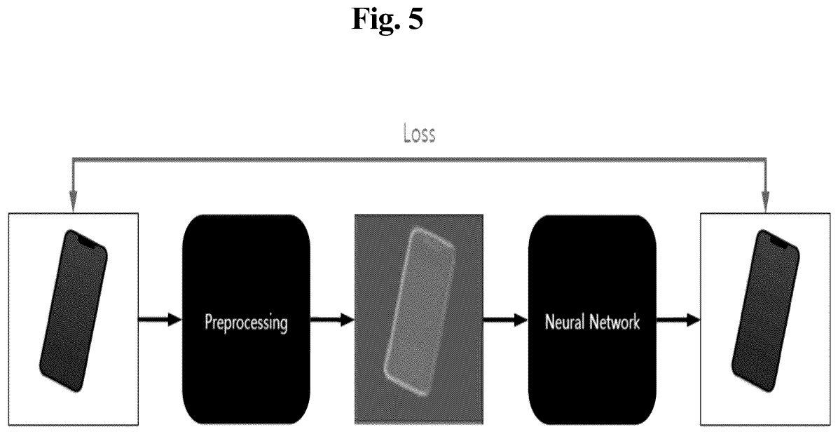

To assist in understanding of the description, FIG. 4 illustrates an example of a series of training processes of an artificial neural network, performed when a mosaic processing (mosaic to image (M2I)) scheme is selected for preprocessing of a normal training image, and in addition, FIG. 5 illustrates an example of a series of training processes of an artificial neural network, performed when an attention map (attention map to image (A2I)) is selected for preprocessing of a training image.

Hereinafter, the other elements in the anomaly detection apparatus 100 are described under the assumption that the training of the artificial neural network has been completed through the above-described elements.

The preprocessing unit 120 is configured to perform a function of performing preprocessing for an input image.

More specifically, the preprocessing unit 120 generates a context image obtained by removing detailed information from the input image by performing preprocessing for the input image.

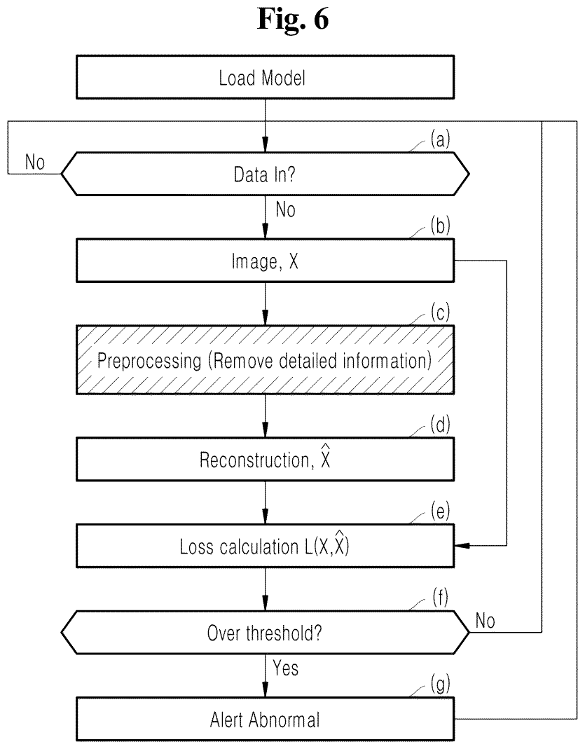

This corresponds to a preprocessing process (c) in FIG. 6, in which a context image is generated in the scheme of when an input image X is input (a and b), removing detailed information from the input image X.

According to an embodiment of the present disclosure, similar to the training process of the artificial neural network, the preprocessing is based on the fact that a separate artificial neural network for performing preprocessing is not required.

Accordingly, the preprocessing unit 120 may generate a context image obtained by removing detailed information from a normal training image by applying, as a preprocessing scheme of requiring no artificial neural network, at least one preprocessing scheme among, for example, mosaic processing (mosaic to image (M2I)), quantization processing (quantized image to image (Q2I)), blurring processing (blurred image to image (B2I)), edge processing (edge image to image (E2I)), and noise processing (noisy image to image (N21)).

According to an embodiment of the present disclosure, unlike the above-described preprocessing scheme of requiring no separate artificial neural network, the preprocessing can be also performed through the artificial neural network.

In this case, the preprocessing unit 120 may generate a context image obtained by removing detailed information from a normal training image by applying, as a preprocessing scheme using an artificial neural network, at least one preprocessing scheme among, for example, an attention map (attention map to image (A2I)), a depth map (depth map to image (D2I)), and a segmentation map (segmentation map to image (S2I)).

The restoration 130 is configured to perform a function of converting the context image into the restoration image.

More specifically, when a context image obtained by removing detailed information from the input image is generated, the restoration unit 130 converts the context image into the restoration image through the artificial neural network.

This corresponds to the above-described restoration process (d) in FIG. 6, in which the context image is approximated to an input image X before removal of the detailed information through the artificial neural network and converted into the restoration image \hat{X}, after the context image generation process (c) through the preprocessing.

In the case of the artificial neural network for converting the context image into the restoration image, like the training process of the artificial neural network, U-Net, which is widely used for image conversion, may be used, but the configuration thereof can be changed if the image conversion can be performed, a convolutional neural network widely used for image processing can be used, and there is no separate limit so that a feed forward network (multi-layer perceptron), a recurrent neural network, and a graph neural network can be selectively used, or one or more of the above-described schemes can be combined.

The determination unit 140 is configured to perform a function of determining whether the input image is abnormal.

More specifically, the determination unit 140 is configured to determine, based on a loss between the input image and the restoration image converted from the context image, whether the input image is abnormal.

In this case, when the loss calculated between the restoration image converted from the context image and the input image is equal to or greater than a threshold value, the determination unit 140 may determine that the input image is abnormal.

This may be understood as a process (e) of calculating a loss between a restoration image \hat{X} and an input image X, and processes (f and g) of when the calculated loss is equal to or greater than a threshold value, determining that the input image is abnormal, and alerting the same when the input image is determined as abnormal, after the restoration process (d) of approximating the context image to the input image X before removal of the detailed information and converting the same into the restoration image \hat{X}, as illustrated in FIG. 6 above.

In the case of the artificial neural network according to an embodiment of the present disclosure, only normal data is learned, thus the artificial neural network has characteristics of converting any input image having detailed information removed therefrom into a normal image, and according to such characteristics, information on a fault part fades and mutates into the normal image in a detailed information removal process.

The loss between the input image and the restoration image corresponding to a result of attempting to restore detailed information through the artificial neural network becomes smaller in the normal input, but becomes larger in the abnormal input, and thus the input image may be determined, based thereon, as the abnormal image when the loss exceeds the threshold value.

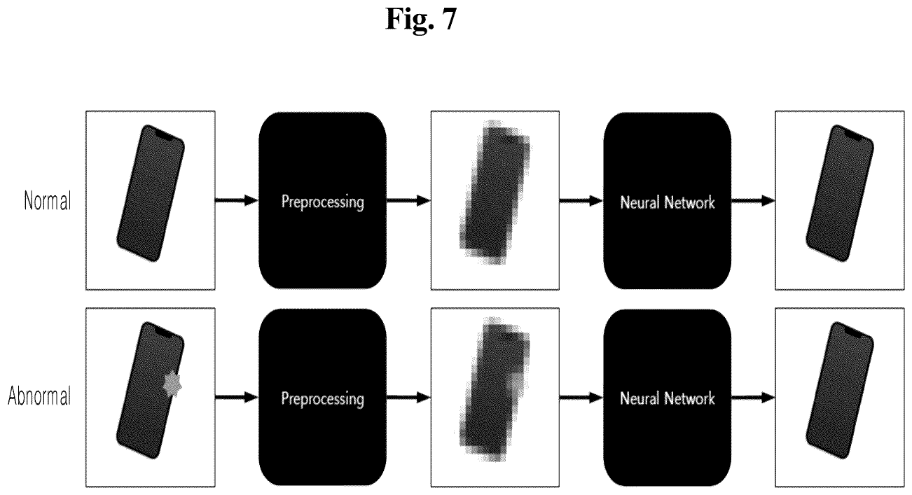

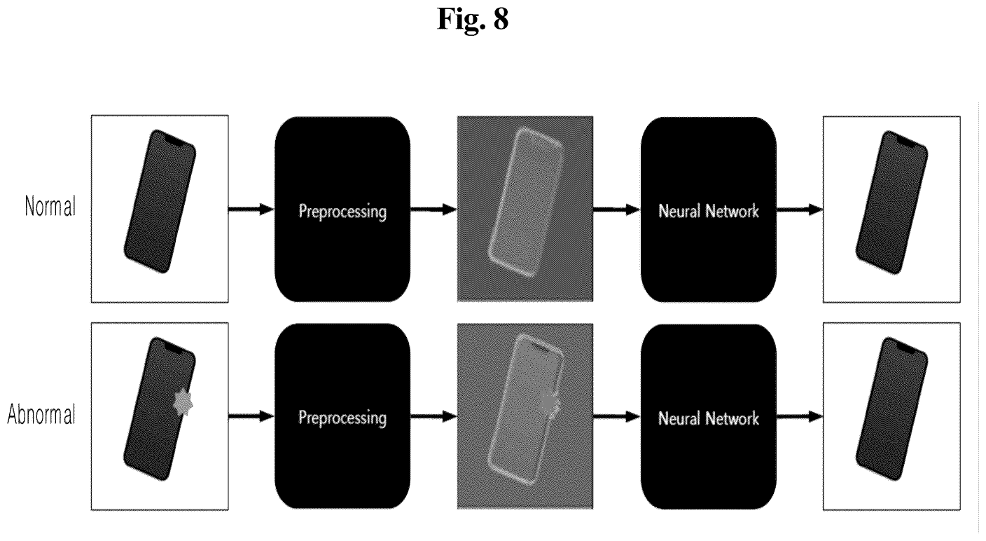

To assist in understanding the description, FIG. 7 illustrates an example of a series of anomaly detection processes performed using an artificial neural network when a mosaic processing (mosaic to image (M2I)) scheme is selected for preprocessing of an input image, and in addition, FIG. 8 illustrates an example of a series of anomaly detection processes performed using an artificial neural network when an attention map (attention map to image (A2I)) is selected for preprocessing of an input image.

As described above, according to the configuration of the anomaly detection apparatus 100 according to an embodiment of the present disclosure, unlike the normal image, the restoration loss of which is minimized, image conversion of maximizing a restoration loss for an abnormal image is performed using an artificial neural network trained to restore again detailed information removed from a normal image (data), whereby the performance of anomaly detection can be greatly improved without extension of the scale of the artificial neural network.

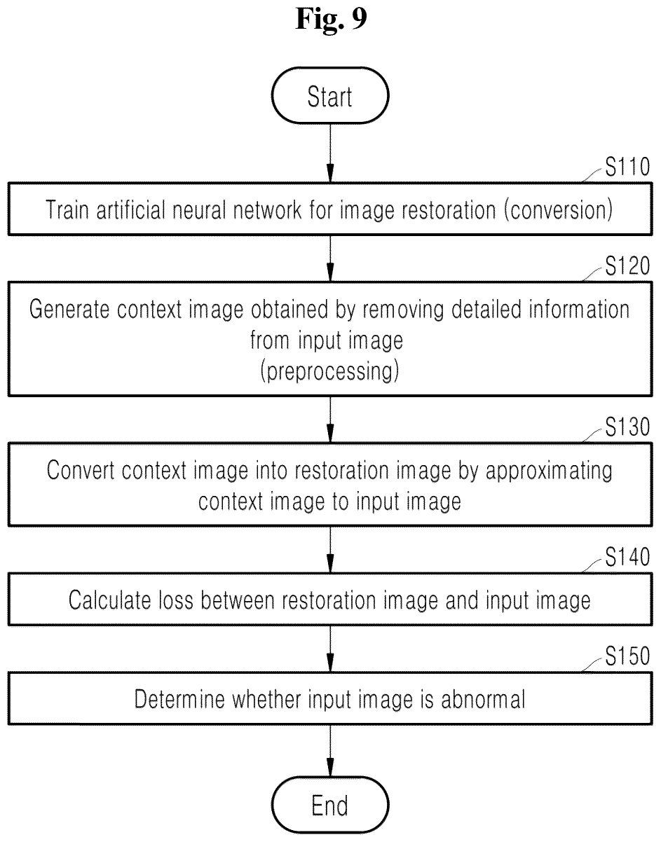

Hereinafter, an anomaly detection method according to an embodiment of the present disclosure is described with reference to FIG. 9.

For convenience of description, in the description below, as an entity for performing an anomaly detection method, the anomaly detection apparatus 100 described with reference to FIG. 2 is mentioned.

First, the anomaly detection apparatus 100 trains an artificial neural network for image restoration in a scheme of restore again detailed information removed from a normal training image (S110).

To this end, the anomaly detection apparatus 100 performs preprocessing for removing detailed information from a normal training image.

This corresponds to the above-illustrated preprocessing process (c) in FIG. 3 in which when a training image X corresponding to a normal image X is input (a and b), a context image is generated in a scheme of removing detailed information from the input training image X.

According to an embodiment of the present disclosure, the above-described preprocessing process is based on the fact that a separate artificial neural network for performing preprocessing is not required.

Accordingly, the anomaly detection apparatus 100 may generate a context image obtained by removing detailed information from the normal training image by applying, as a preprocessing scheme of requiring no artificial neural network, at least one preprocessing scheme among, for example, mosaic processing (mosaic to image (M2I)), quantization processing (quantized image to image (Q2I)), blurring processing (blurred image to image (B2I)), edge processing (edge image to image (E2I)), and noise processing (noisy image to image (N21)).

According to an embodiment of the present disclosure, unlike the above-described preprocessing scheme of requiring no separate artificial neural network, the preprocessing may be also performed through the artificial neural network.

In this case, the anomaly detection apparatus 100 may generate a context image obtained by removing detailed information from a normal training image by applying, as a preprocessing scheme using an artificial neural network, at least one preprocessing scheme among, for example, an attention map (attention map to image (A2I)), a depth map (depth map to image (D2I)), and a segmentation map (segmentation map to image (S2I)).

In addition, the anomaly detection apparatus 100 converts the context image into a restoration image through the artificial neural network when the context image obtained by removing the detailed information from the normal training image is generated.

This corresponds to the above-illustrated restoration process (d) in FIG. 3 above, in which the context image is approximated to a training image X before removal of the detailed information through the artificial neural network, and converted into a restoration image \hat{X}, after the context image generation through preprocessing (c).

In a case of the artificial neural network for converting the context image into the restoration image, for example, U-Net, which is widely used for image conversion, may be used, but the configuration thereof can be changed if image conversion can be performed.

In configuring the artificial neural network, a convolutional neural network widely used for image processing may be used, and there is no separate limit so that a feed forward network (multi-layer perceptron), a recurrent neural network, and a graph neural network can be selectively used, or one or more of the above-described schemes can be combined.

Moreover, the anomaly detection apparatus 100 is configured to repeat, when the context image is converted into the restoration image obtained by approximating the training image through the artificial neural network, parameter updating until a loss between the converted restoration image and the training image falls within a configuration value.

This corresponds to the above-illustrated process (e) of calculating a loss between the restoration image \hat{X} and the training image X, and the updating process (f) in which parameter updating of the artificial neural network is repeated until the calculated loss falls within the configuration value, after the above-illustrated restoration process (d) in FIG. 3 of approximating the context image to the training image X before removal of the detailed information and converting the same into the restoration image \hat{X}.

The artificial neural network according to an embodiment of the present disclosure is trained to receive an input obtained by removing detailed information and converting the same into an image before removal of the detailed information, and according this rule, the training is performed in the direction of minimizing a loss between an original image and an output obtained from the artificial neural network.

To assist in understanding of the description, FIG. 4 illustrates an example of a series of training processes of an artificial neural network, performed when a mosaic processing (mosaic to image (M2I)) scheme is selected for preprocessing of a normal training image, and in addition, FIG. 5 illustrates an example of a series of training processes of an artificial neural network, performed when an attention map (attention map to image (A2I)) is selected for preprocessing of a training image.

Hereinafter, the other elements in the anomaly detection apparatus 100 are described under the assumption that the training of the artificial neural network has been completed through the above-described elements.

Moreover, the anomaly detection apparatus 100 performs preprocessing of an input image to generate a context image obtained by removing detailed information from the input image (S120).

This corresponds to the above-illustrates preprocessing process (c) in FIG. 6, in which a context image is generated in the scheme of when an input image X is input (a and b), removing detailed information from the input image X.

According to an embodiment of the present disclosure, similar to the training process of the artificial neural network, the preprocessing is based on the fact that a separate artificial neural network for performing preprocessing is not required.

Accordingly, the anomaly detection apparatus 100 may generate a context image obtained by removing detailed information from a normal training image by applying, as a preprocessing scheme of requiring no artificial neural network, at least one preprocessing scheme among, for example, mosaic processing (mosaic to image (M2I)), quantization processing (quantized image to image (Q2I)), blurring processing (blurred image to image (B2I)), edge processing (edge image to image (E2I)), and noise processing (noisy image to image (N21)).

According to an embodiment of the present disclosure, unlike the above-described preprocessing scheme of requiring no separate artificial neural network, the preprocessing can be also performed through the artificial neural network.

In this case, the anomaly detection apparatus 100 may generate a context image obtained by removing detailed information from a normal training image by applying, as a preprocessing scheme using an artificial neural network, at least one preprocessing scheme among, for example, an attention map (attention map to image (A2I)), a depth map (depth map to image (D2I)), and a segmentation map (segmentation map to image (S2I)).

Thereafter, when a context image obtained by removing detailed information from the input image is generated, the anomaly detection apparatus 100 converts the context image into the restoration image through the artificial neural network (S130).

This corresponds to the above-described restoration process (d) in FIG. 6, in which the context image is approximated to an input image X before removal of the detailed information through the artificial neural network and converted into the restoration image, after the context image generation process (c) through the preprocessing.

In the case of the artificial neural network for converting the context image into the restoration image, like the training process of the artificial neural network, U-Net, which is widely used for image conversion, may be used, but the configuration thereof can be changed if the image conversion can be performed, a convolutional neural network widely used for image processing can be used, and there is no separate limit so that a feed forward network (multi-layer perceptron), a recurrent neural network, and a graph neural network can be selectively used, or one or more of the above-described schemes can be combined.

Thereafter, the anomaly detection apparatus 100 determines, based on a loss between the input image and the restoration image converted from the context image, whether the input image is abnormal (S140 and S150).

In this case, when the loss calculated between the restoration image converted from the context image and the input image is equal to or greater than a threshold value, the anomaly detection apparatus 100 may determine that the input image is abnormal.

This may be understood as the process (e) of calculating a loss between a restoration image \hat{X} and an input image X, and the processes (f and g) of when the calculated loss is equal to or greater than a threshold value, determining that the input image is abnormal, and alerting the same when the input image is determined as abnormal, after the restoration process (d) of approximating the context image to the input image X before removal of the detailed information and converting the same into the restoration image \hat{X}, as illustrated in FIG. 6 above.

The artificial neural network according to an embodiment of the present disclosure learns only normal data, and thus has characteristics of converting any input image having detailed information removed therefrom into a normal image, and according to such characteristics, information on a fault part fades and mutates into the normal image in a detailed information removal process.

The loss between the input image and the restoration image corresponding to a result of attempting to restore detailed information through the artificial neural network becomes smaller in the normal input, but becomes larger in the abnormal input, and thus the input image may be determined, based thereon, as the abnormal image when the loss exceeds the threshold value.

To assist in understanding the description, FIG. 7 illustrates an example of a series of anomaly detection processes performed using an artificial neural network when a mosaic processing (mosaic to image (M2I)) scheme is selected for preprocessing of an input image, and in addition, FIG. 8 illustrates an example of a series of anomaly detection processes performed using an artificial neural network when an attention map (attention map to image (A2I)) is selected for preprocessing of an input image.

As described above, according to the anomaly detection method according to an embodiment of the present disclosure, unlike the normal image, the restoration loss of which is minimized, image conversion of maximizing a restoration loss for an abnormal image is performed using an artificial neural network trained to restore again detailed information removed from a normal image (data), whereby the performance of anomaly detection can be greatly improved without extension of the scale of the artificial neural network.

The implementations of the functional operations and subject matter described in the present disclosure may be realized by a digital electronic circuit, by the structure described in the present disclosure, and the equivalent including computer software, firmware, or hardware including, or by a combination of one or more thereof. Implementations of the subject matter described in the specification may be implemented in one or more computer program products, that is, one or more modules related to a computer program command encoded on a tangible program storage medium to control an operation of a processing system or the execution by the operation.

A computer-readable medium may be a machine-readable storage device, a machine-readable storage substrate, a memory device, a composition of a machine-readable material having influence on electronic wave type signals, or a combination of one or more thereof.

In the specification, the term “system” or “device”, for example, covers a programmable processor, a computer, or all kinds of mechanisms, devices, and machines for data processing, including a multiprocessor and a computer. The processing system may include, in addition to hardware, a code that creates an execution environment for a computer program when requested, such as a code that constitutes processor firmware, a protocol stack, a database management system, an operating system, or a combination of one or more thereof.

A computer program (also known as a program, software, software application, script, or code) may be written in any form of programming language, including compiled or interpreted languages, declarative or procedural languages, and it may be deployed in any form, including as a stand-alone program or module, a component, subroutine, or another unit suitable for use in a computer environment. A computer program may, but need not, correspond to a file in a file system. A program may be stored in a single file provided to the requested program, in multiple coordinated files (for example, files that store one or more modules, sub-programs, or portions of code), or in a portion of a file that holds other programs or data (for example, one or more scripts stored in a markup language document). A computer program may be deployed to be executed on one computer or on multiple computers that are located at one site or distributed across a plurality of sites and interconnected by a communication network.

A computer-readable medium suitable for storing a computer program command and data includes all types of non-volatile memories, media, and memory devices, for example, a semiconductor memory device such as an EPROM, an EEPROM, and a flash memory device, and a magnetic disk such as an external hard disk or an external disk, a magneto-optical disk, a CD-ROM, and a DVD-ROM disk. A processor and a memory may be added by a special purpose logic circuit or integrated into the logic circuit.

The implementations of the subject matter described in the specification may be implemented in a calculation system including a back-end component such as a data server, a middleware component such as an application server, a front-end component such as a client computer having a web browser or a graphic user interface which can interact with the implementations of the subject matter described in the specification by the user, or all combinations of one or more of the back-end, middleware, and front-end components. The components of the system can be mutually connected by any type of digital data communication such as a communication network or a medium.

While the specification contains many specific implementation details, these should not be construed as limitations to the scope of any disclosure or of what may be claimed, but rather as descriptions of features that may be specific to particular embodiments of particular disclosures. Certain features that are described in the specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

In addition, in the specification, the operations are illustrated in a specific sequence in the drawings, but it should be understood that the operations are not necessarily performed in the shown specific sequence or that all shown operations are necessarily performed in order to obtain a preferable result. In a specific case, multitasking and parallel processing may be preferable. Furthermore, it should not be understood that a separation of the various system components of the above-mentioned implementation is required in all implementations. In addition, it should be understood that the described program components and systems usually may be integrated in a single software package or may be packaged in a multi-software product.

The specific terms as set forth herein are not intended to limit the present disclosure. Therefore, while the present disclosure was described in detail with reference to the above-mentioned examples, those skilled in the art may modify, change, and transform some parts without departing a scope of the present disclosure. The scope of the present disclosure is defined by the appended claims as described below, rather than the above detailed description, and accordingly, it should be understood that all changes or modifications derived from the meaning and scope of the claims and equivalents thereof also fall within the scope of the present disclosure.

What is claimed is:

1. An anomaly detection apparatus comprising:
a preprocessing unit configured to generate a context image obtained by removing detailed information from an input image;
a restoration unit configured to approximate the context image to the input image through an artificial neural network so as to convert the context image into a restoration image; and
a determination unit configured to determine whether the input image is abnormal based on a loss between the input image and the restoration image converted from the context image.

2. The anomaly detection apparatus of claim 1, further comprising a training unit configured to train the artificial neural network by restoring detailed information removed from a normal training image.

3. The anomaly detection apparatus of claim 2, wherein the training unit is configured to update a parameter of the artificial neural network so that a loss between the training image and a restoration image obtained by approximating a context image from which the detailed information is removed from the training image to the training image falls within a configuration value.

4. The anomaly detection apparatus of claim 1, wherein the determination unit is configured to determine that the input image is abnormal when the loss between the input image and the restoration image converted from the context image is equal to or greater than a threshold value.

5. An anomaly detection method comprising:
generating a context image obtained by removing detailed information from an input image is generated;
approximating the context image to the input image through an artificial neural network so as to convert the context image into a restoration image; and
determining whether the input image is abnormal based on a loss between the input image and the restoration image converted from the context image.

6. The anomaly detection method of claim 5, further comprising training the artificial neural network by restoring detailed information removed from a normal training image.

7. The anomaly detection method of claim 6, wherein the training comprises updating a parameter of the artificial neural network so that a loss between the training image and a restoration image obtained by approximating a context image from which the detailed information is removed from the training image to the training image falls within a configuration value.

8. The anomaly detection method of claim 5, wherein the determining comprises determining that the input image is abnormal when the loss between the input image and the restoration image converted from the context image is equal to or greater than a threshold value.

9. A non-transitory computer-readable recording medium storing instructions thereon, the instructions when executed by a processor cause the processor to:
generate a context image obtained by removing detailed information from an input image is generated;
approximate the context image to the input image through an artificial neural network so as to convert the context image into a restoration image; and
determine whether the input image is abnormal based on a loss between the input image and the restoration image converted from the context image.
